(19) United States
(12) Patent Application Publication
(10) Pub. No.: US 2023/0214796 A1
(43) Pub. Date: Jul. 6, 2023

(54) REAL-TIME MULTIPLE-ACCESS EXCHANGE-PARTY-FREE COUNTERPARTY-SECURE EXCHANGE

(71) Applicants: Jeff Jay Hilde, Martinsburg, PA (US); Austin Lee Hilde, Hayden, CO (US); Brandon James Hilde, Sandy, OR (US)

(72) Inventors: Jeff Jay Hilde, Martinsburg, PA (US); Austin Lee Hilde, Hayden, CO (US); Brandon James Hilde, Sandy, OR (US)

(21) Appl. No.: 18/146,716

(22) Filed: Dec. 27, 2022

Related U.S. Application Data
(60) Provisional application No. 63/263,116, filed on Oct. 27, 2021.

(51) Int. Cl. G06Q 20/06; G06Q 20/38; G06Q 20/22

(52) U.S. Cl. CPC G06Q 20/0658; G06Q 20/38215; G06Q 20/223

(57) ABSTRACT

A system, method, apparatus, and computer software for conducting real-time cross-network counterparty-secure exchange-party-free crypto currency payments, trade, and exchange. The system includes decentralized processing computers operating together peer-to-peer in communication with multiple crypto currency blockchain networks via an internet connection. The method includes requesting a sell or a buy of a Face Value denoted as dx; publishing the request to a market network; accessing transaction data stored in multiple blockchain networks, each of the multiple blockchain networks being different from each other; quoting a value for settlement of the request denoted as dy; verifying the value as according to a predetermined protocol; issuing transactions to effect the request; and producing a trading report. By providing a generalized cryptographic security system, a real-time multiple-access exchange-party-free counterparty-secure exchange is made possible offering a huge market extremely valuable features that are not currently available to crypto currency exchange system users.

### CROSS-REFERENCE TO RELATED APPLICATION

This application claims the benefit of priority of U.S. provisional application No. 63/263,116, filed Oct. 27, 2021, the contents of which are herein incorporated by reference.

### BACKGROUND OF THE INVENTION

The present invention relates to cryptocurrency and, more particularly, to cryptocurrency trading.

Currently crypto trading systems are centralized and are not secure in the cryptographic sense as are the crypto currencies themselves. Centralized exchanges do not have cryptographic security. The central exchanges have been the subject of billions of dollars' worth of stolen crypto currency because of the concentration of crypto in the hands of an exchange party, making it an easy target for insider theft or a very large payoff for an outsider hack. For example, consider the Mt. Gox collapse in 2014 and a recent incident in January 2022, where more than $30 million was stolen by hackers from Crypto-dot-com. The problem with central exchange is user must trust the exchange with their funds as an intermediary giving up custody of their crypto, exposing them to a security risk.

Decentralized exchanges have limited domain within a single blockchain network and do not have protocols for cross-chain exchange, i.e., there is no exchange possible between different types of blockchain networks. They have not employed a security system that is sufficiently generalized to allow integration of multiple network platforms together into a single cryptographically secured exchange network of users. Thus, crypto traders on decentralized exchanges are limited to the tokens that are available on a single blockchain

Ad hock trading does not have a live market and price discovery. Meet-up exchange is not real-time.

Solutions have been implemented that work on a single blockchain network but solutions to trade across multiple blockchain networks that don't involve an exchange party, and the associated risk, have not been found. U.S. Pat. No. 10,592,985B2 depends on a proposal message and an acceptance signal before an action is performed. U.S. Pat. No. 11,372,848B2 depends on “a corresponding set of transactions published on at least two of the blockchains” and on Hash Time Locked Contracts. Ad hock Crypto traders that use hashed time locked contracts do not enjoy live market trading. U.S. Pat. No. 11,093,651B2 depends on a trusted execution environment to build and validate a relay blockchain.

As can be seen, there is a need for improved systems, methods, apparatus, and computer software for providing a real-time, multiple-access, exchange-party-free, counterparty-secure exchange.

The present invention enables live trading across multiple blockchain networks that does not require an exchange party, thus eliminating the associated risk of loss.

### SUMMARY OF THE INVENTION

In one aspect of the present invention, a computer-implemented decentralized method for managing transactions across multiple blockchain networks with generalized cryptographic security comprises requesting a payment, sell, or buy, of a Face Value denoted as dx; publishing the request to a market network; accessing transaction data stored in multiple blockchain networks, each of the multiple blockchain networks being different from each other; quoting a value for settlement of the request denoted as dy; verifying the value as according to a predetermined protocol; issuing transactions to effect the request; and producing a trading report.

In another aspect of the present invention, a system comprises decentralized processing computers operating together peer-to-peer in communication with multiple crypto currency blockchain networks via an internet connection; and software executed by the decentralized processing computers to implement the computer-implemented decentralized method.

In another aspect of the present invention, a crypto currency super block comprises confirmed crypto blocks from multiple blockchains, the crypto blocks containing autonomous scrip processed as a unit by the computer-implemented decentralized method.

The generalized cryptographic security system of the present subject matter enables a real-time, multiple-access, exchange-party-free, counterparty-secure exchange, offering a huge market extremely valuable features that are not currently available to crypto currency exchange system users. Traders may retain custody of their crypto and have cross-chain access, while retaining the convenience of live market trading with automated price discovery. Trading is made safe using blockchain technology as a peer-to-peer digital currency.

A user, without opening an account at an exchange party facility, may enter orders to buy and sell crypto currency via the system and enjoy real-time cross-blockchain counterparty-secure exchange-party-free automated execution results.

The automated quoting feature enables value to be automatically determined in terms of multiple crypto currencies which allows cross-network trading. These features are useful as they are viable long term.

The autonomous market system removes centralized exchanges from making markets, eliminating the associated exchange-party risk. The concurrency and response-flow features employ the current cryptographic security of blockchains for counter-party transactions, in addition to the single-party transaction cryptographic security already in use.

The new trade transaction accomplishes simultaneous transfers of a crypto in exchange for other crypto such that the custodians of the cryptos retain control of their value before, during and after the transfers. No exchange-party is ever involved. It may be used to determine the quantities of a product in inventory to meet demand without running out of supply. This is especially relevant for anything that is hard to price in advance, such as valuables that have no market outside some internal system of supply and demand.

These and other features, aspects and advantages of the present invention will become better understood with reference to the following drawings, description, and claims.

### BRIEF DESCRIPTION OF THE DRAWINGS

FIG. 1 is a schematic diagram of a prior art centralized exchange cryptocurrency trading system;

FIG. 2 is a schematic diagram of a prior art decentralized exchange cryptocurrency trading system;

FIG. 3 is a schematic diagram of a decentralized crypto-swap block exchange according to an embodiment of the present invention;

FIG. 4 is a flowchart of a method of proof of relay according to an embodiment of the present invention; and

FIG. 5 is a concurrent send transaction diagram according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Terminology used herein is intended to have its ordinary meaning according to one of ordinary skill in the art. The following terminology will be used as defined below unless otherwise specified.

“Crypto” refers to wealth in the form of money, equity or other assets that are face valued and owned by an entity (i.e., person or organization) that is available to, or has been contributed to, a particular kind of digital network of fungible property controlled by digital network transactions that conform to a consensus of the network member processing nodes. The consensus includes validation of the transactions that involve the use of secret numbers to assert and recognize authority required to transfer ownership of the property.

“Kind” refers to Crypto that belongs to a particular distinct class that may be contracted for by face value without an individual specimen being specified and is able to replace or be replaced by other Crypto of the same class and is mutually interchangeable by face value on a one-to-one value basis.

“Sum” is a sum of the face values of individual specimens of the same Kind of Crypto.

“Account” is an address of Crypto that is, or may be made, available to send and receive and hold a Sum for at least two different Kinds of Crypto of which at least one Kind of Crypto is a Cash Kind that may be sent from a first address and received by a second address and of which at least one Kind of Crypto is an Equity Kind that cannot be sent from the first address and received by the second address.

“Cash” is a Kind of Crypto that is, or may be made, available to be sent, received, and held using an Account.

“Equity” is a Kind of Crypto that is native to its blockchain and can be sent and received and held using the native functionality of its blockchain protocol.

“Autonomous Scrip” is a kind of digital message such as a trading order for autonomous processing that receives a user action of direct Equity control and makes an autonomous reaction of feedback Cash control: the user action of direct Equity control being used; transfer Equity by decreasing an Equity Sum in an Account and increasing an Equity Sum in another Account, where the amount of the transfer in Equity is determined by the direct control of user specification and confirmed by the user digital signature of the digital message; and the autonomous reaction of feedback Cash control being used to transfer Cash by decreasing a Cash Sum in an Account and increasing a Cash Sum in another Account, where the amount of the transfer in Cash is determined by the feedback control of Autonomous Pricing and is confirmed by consensus.

“Circulating” describes Cash or Equity Crypto that is present in Accounts.

“Uncirculated” describes Cash or Equity Crypto that is not present in Accounts but is available to become Circulating Crypto.

“Autonomous Pricing” is an automated pricing facility that determines a quantity of Cash used as the market value, or as the amount to be traded, in exchange for a quantity of Equity, where the quantities are determined by taking a sum (X) of Uncirculated Cash, a sum (Y) of Circulating Equity, a quantity of Cash (dx) to be added to (X+dx) or subtracted from (X−dx) Uncirculated Cash, and a quantity of Equity (dy) to be added to (Y+dy) or subtracted from (Y−dy) Circulating Equity, where at least one of the factored combinations of the following equation is true: (X) (Y)=(X±dx) (Y±dy), when not including trading fees, spreads, markups, markdowns, discounts and/or premiums; and where the automated pricing is decentralized and serialized by consensus with respect to the sums of Uncirculated Cash and Circulating Equity, such as is done by the inventive Proof of Relay consensus mechanism.

A “Difficult Proof of Validity” is a difficult proof that a block is valid, such as, for example, proof of work, proof of stake, and combinations or variations of these, including: (a) choose to continue the current negotiating in efforts to direct consent towards a block of one's own choosing or choose to discontinue the current negotiation and start negotiation on a new block of one's own choosing; and (b) combination of proof of work and stake where the Difficult Proof of Validity is the product of a proof of work and a proof of stake.

“Proof of Stake” (PoS) is a consensus mechanism for validating cryptocurrency transactions. Validators commit some of their cryptocurrency coins as a stake. When they discover a candidate block that can be added to the chain, they validate it by placing a bet on it. If the block gets appended, the validators get a reward proportionate to their bets.

“Proof of Work” (PoW) is a consensus mechanism in which miners compete to solve each puzzle. When a miner solves the puzzle, it broadcasts its block to the other network nodes for verification.

An “Entrant” is a block processing node in communication with other block processing nodes that has chosen to enter a consensus mechanism protocol to negotiate, among the processing nodes, a next valid block.

“Exceeding a Most Difficult Proof of Validity” is a Consensus Directing Comparison of a recent Difficult Proof of Validity for a block with a most Difficult Proof of Validity. If the recent Difficult Proof of Validity is more difficult than the most Difficult Proof of Validity, the recent Difficult Proof of Validity becomes the most Difficult Proof of Validity for a block and directs consensus to the block. Otherwise, consensus is not directed.

A “Consensus Directing Comparison” is a comparison of a Difficult Proof of Validity with anything that either directs consensus towards a different block or does not direct consensus towards a different block.

“Proof of Relay” is a consensus mechanism that negotiates a next valid block in a type of relay race that starts with a set of blocks that include a first Difficult Proof of Validity that is of no particular difficulty, where each block in the set is given by any and all Entrants to the race that may choose to do so. Each Entrant continues making Difficult Proofs of Validity until, by a Consensus Directing Comparison, the difficulty of a Difficult Proof of Validity is difficult enough to qualify as a negotiating Difficult Proof of Validity. The negotiating Difficult Proof of Validity is negotiated by sending the negotiating Difficult Proof of Validity to the Entrants or receiving a negotiating Difficult Proof of Validity from the Entrants and each Entrant directing consent to the negotiating Difficult Proof of Validity block received first. Each Entrant upon directing consent may choose to continue the current negotiating in efforts to direct consent towards a block of their own choosing or may choose to discontinue the current negotiation and start negotiation on a new block of their own choosing.

“Swopblocks” are super blocks constructed of blockchain blocks that have been confirmed and contain Autonomous Scrip and the super blocks when confirmed by consensus, such as the Proof of Relay consensus mechanism, form a live longest-chain of serialized Autonomous Scrip that is used to enable live cross-blockchain exchange-party-free Equity trading between counterparties that is made safe by using and extending blockchain technology as originally developed as a peer-to-peer digital currency.

The term “hash” refers to a second bit string, an output string, that is obtained by having a cryptographic hash function act upon a file corresponding to a first bit string, as input string.

Broadly, one embodiment of the present invention is a system, method, apparatus, and computer software for a generalized cryptographic security, utilizing superblocks and automated cross-network quoting.

The automated quoting process assumes the price (dy/dx) of exchange is always equal to the ratio of the face value demand (X) and the quote value supply (Y) as expressed in the following equation: (X) (Y)=(X±dx) (Y±dy). Using a separate supply of quote value for each blockchain, the trading is conducted as parallel threads of work that allow real-time market price discovery and user participation for value to flow between them at par value. Autonomous Pricing.

A system according to aspects of the present invention provides access to multiple crypto currency blockchain networks, employs software implemented methods that create buy and sell orders in response to user requests; methods that publish the orders as transactions of the blockchain networks; methods that find matching buy and sell orders; and methods that make final settlement of the orders.

The inventive system produces and consumes market trading orders and reports with specially designed and formatted content in text and binary messaging.

The inventive system creates a network of member subordinate blockchain networks using a novel transaction that involves a concurrent response-flow automated-quoting cross-network payment protocol. Users of the network may buy and sell crypto currencies as peers in an autonomous market system.

A new type of crypto currency acts as the medium of exchange to replace the exchange party role. This crypto currency is referred to herein as “Swopblocks”, a super block that contains crypto blocks from multiple blockchains, the crypto blocks containing trading orders that are processed as a unit. This new currency is hosted on multiple blockchains and is used in a new type of crypto trade transaction. This inventive method provides a protocol driven exchange function that executes in decentralized autonomous processing using Swopblocks and Proof of Relay: a new type of blockchain consensus mechanism that works by first relaying a proof to start and then relaying progress of proof among network nodes in a type of relay race to randomly win the right to define and profit from the next valid Swopblock in a longest chain blockchain.

The blockchain of Swopblocks produced by the Proof of Relay consensus mechanism establishes a deterministic processing sequence that is the same for each peer in a decentralized network in order that the Autonomous Scrip that uses Autonomous Pricing may perform live detailed calculations and come to the exact same result on each peer's processing computer.

The processing computers are decentralized and work together in a peer-to-peer fashion. The computers utilize software executables to come to consensus on a longest-chain of Swopblocks that compute the transactions to automatically fill the trading orders made by users using Autonomous Pricing.

Elements of the inventive system may include at least one computer; an internet connection in communication with multiple crypto currency blockchain networks; and software logic. The computer may include any computer with a user interface including, but not limited to, a desktop, laptop, and smart device, such as a tablet and smart phone. The computer operates software including a machine-readable program code which causes, when executed, the computer to perform steps. In some embodiments, the system may employ elements commonly used in online crypto and stock exchanges, such as mobile phone apps with market reports and charts and ease-of-use human interfacing.

The software may either be loaded onto the computer or accessed by the computer. The loaded software may include an application on a smart device. The software may be accessed by the computer using a web browser. The computer may access the software via the web browser using an/the internet, extranet, intranet, host server, internet cloud and the like.

The software may combine blocks from at least two blockchain networks into super blocks, i.e., Swopblocks, that are constructed of blockchain blocks that have been confirmed and contain Autonomous Scrip used to enable live cross-blockchain exchange-party-free Equity trading between counterparties. Super blocks that contain regular blocks from multiple different blockchains are sequenced in a live longest chain consensus mechanism of serialized Autonomous Scrip. The Swopblocks may be confirmed by consensus, such as the Proof of Relay consensus mechanism. The regular blocks contain transactions that conform to a trading protocol. The trading protocol uses a market data-driven pricing protocol to enable the identification of value to be preserved to the custodians. The trading protocol changes custody of that value in a single autonomous concurrent transaction that acts as a type of smart contract escrow, eliminating the role of an exchange or escrow party.

Steps of the inventive method may include the following: requesting a Face Value sell or buy, the Face Value denoted as dx; publishing a request to the market network; accessing multiple blockchain networks; issuing transactions to effect the request; quoting a value for settlement of the request denoted as dy; verifying the quote value as according to protocol; supplying a reserve Quote Value denoted as Y; and supplying a circulating Face Value denoted as X.

A particular market order to buy and sell Face Value is published into an automated exchange protocol that keeps a history of all such market orders. From the history, a particular mate is found by looking for another order that has an exchange price determined as a function of the market order and the exact mating volume that is up next to be matched according to the type of Face Value buy order to be mated with a sell order. The exact volume to be used to settle the buy-sell mated orders and the transaction to accomplish this mated order is automated in the software logic and is executed on behalf of the parties to the exchange. If an exchange of Face Value and Quote Value is valid then the following equation is true: XY=(X+dx)(Y−dy).

While buy and sell orders and order settlements can be in random order, the exchange quote value is determined before settlement and is based on an exact understanding of the entire history of the settlements in order to precisely determine the quote value of an order such that all participants can execute an independent determination of the quote value and never make a determination that does not match each of the other participants' determination of such quote value.

An automated pricing facility determines a quantity of Cash used as the market value or as the amount to be traded in exchange for a quantity of Equity where the quantities are determined by taking a sum (X) of Uncirculated Cash, a sum (Y) of Circulating Equity, a quantity of Cash (dX) to be added (X+dX) to Uncirculated Cash or subtracted from Uncirculated Cash (X−dX), and a quantity of Equity (dY) to be added (Y+dY) to Circulating Equity or subtracted (Y−dY) from Circulating Equity such that one of the following four combinations of equations of equality is true: (X) (Y)=(X±dX) (Y±dY), and where the automated pricing is decentralized and serialized by consensus with respect to the sums of Uncirculated Cash and Circulating Equity, an example of the consensus being a proof of work, a proof of stake, or some combination or variation of these such as the Proof of Relay consensus mechanism of this invention.

A user, without opening an account at an exchange party facility, may enter orders to buy and sell crypto currency via the system and enjoy the real-time cross-blockchain counterparty-secure exchange-party-free automated execution results. The user may review the current prices of cryptocurrency in which he or she is interested in buying or selling. The user may decide on a crypto to buy; an amount the user is willing to pay; and a crypto with which to pay. The user may enter the trading order and gain custody of the crypto bought (from one blockchain) in automated exchange for custody of the crypto used to pay (from another blockchain). The transaction is live trade and custodial change with no intermediate party.

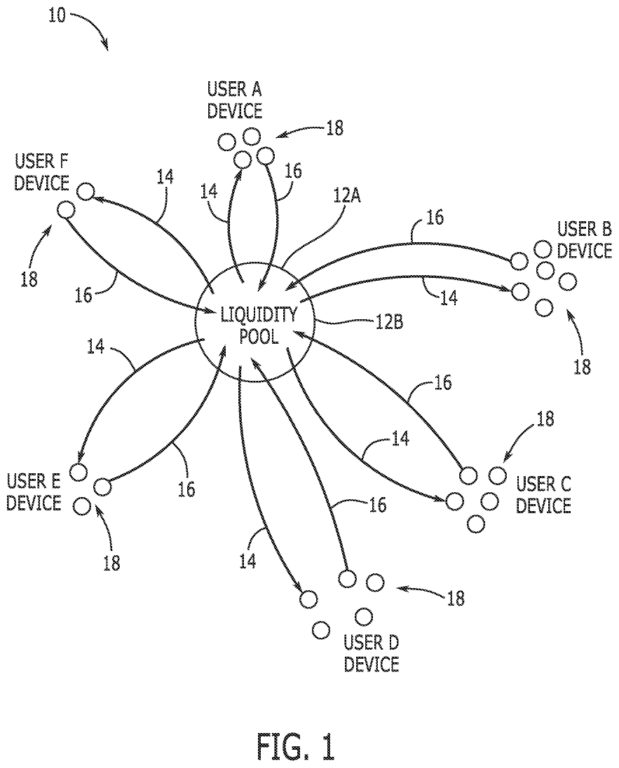

Referring to FIGS. 1 through 5, FIG. 1 illustrates a prior art centralized exchange cryptocurrency trading system 10, having a liquidity pool with higher risk centralized liquidity 12A under higher risk centralized custody 12B. Users A, B, C, D, E, F with crypto-coins 18, using their devices, receive data 14 and send data 16 with high risk.

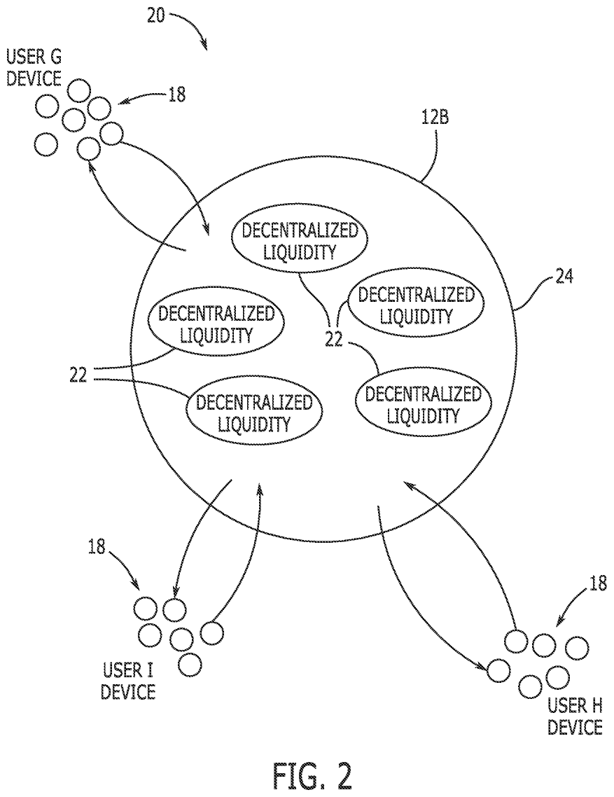

FIG. 2 illustrates a prior art crypto-decentralized exchange (DEX) 20, having a liquidity pool with low risk decentralized liquidity 22 under higher risk centralized custody 12B on a hackable bridge server device 24. Users G, H, I with crypto-coins 18, using their devices, transact trades with some risk.

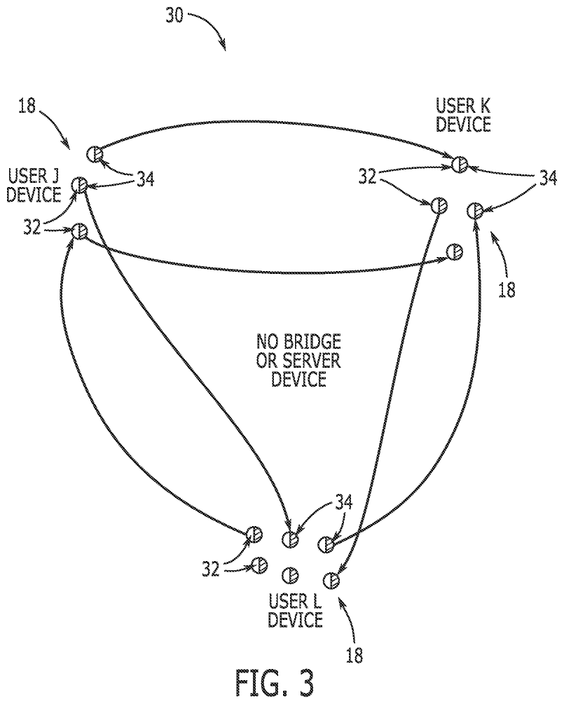

A crypto-swap block exchange 30 according to an embodiment of the present invention is shown in FIG. 3. Each user J, K, L, has decentralized custody 32 of their crypto coins 18 via their devices and has decentralized liquidity 34. No bridge or server device is used to manage the trades, eliminating a risk of hacking such a device.

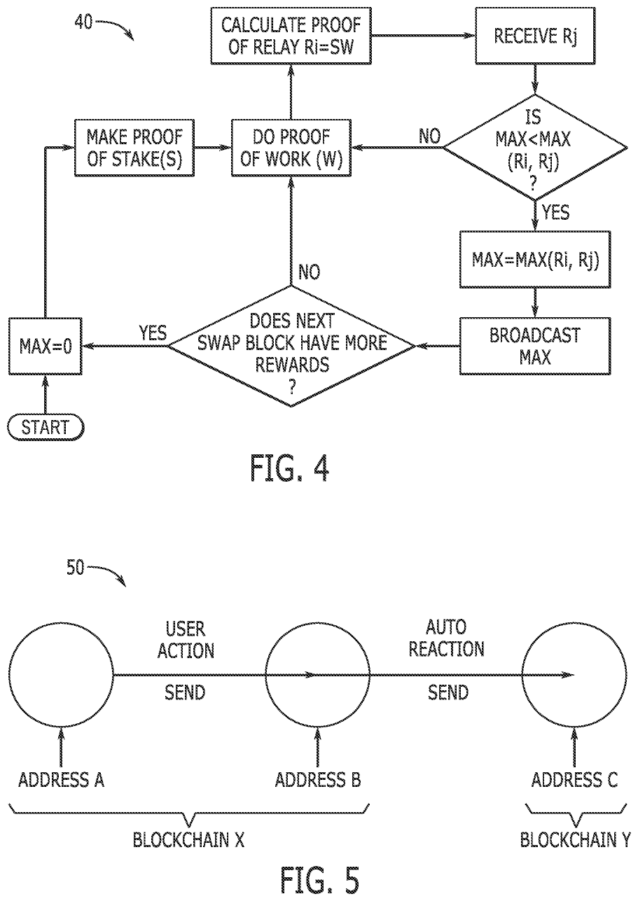

A proof of relay 40 process according to an embodiment of the present invention is illustrated in FIG. 4. Beginning with a set maximum=0, the proof of stake mechanism is enacted, followed by the proof of work mechanism. The system calculates a Proof of Relay (Ri) equal to the product of the proof of stake and the proof of work. The previously set maximum is compared to a maximum of the proof of relay and the receive value Rj. If the previously set maximum is greater than or equal to the proof of relay/receive maximum, the system returns to proof of work. Otherwise, the maximum is set to the proof of relay/receive maximum, which is broadcast. If the next Swopblock has more rewards, the maximum is returned to 0 and the process starts again. If the next Swopblock does not have more rewards, the system returns to Proof of Work.

A concurrent send transaction 50 according to an embodiment of the present invention is illustrated in FIG. 5. Address A of blockchain X sends data due to user action to Address B of blockchain X. Address B automatically sends data to Address C of blockchain Y.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system accessible by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented decentralized method for managing transactions across multiple blockchain networks with generalized cryptographic security, comprising:
requesting a sell or a buy of a Face Value denoted as dx;
publishing the request to a market network;
accessing transaction data stored in multiple blockchain networks, each of the multiple blockchain networks being different from each other;
quoting a value for settlement of the request denoted as dy;
verifying the value as according to a predetermined protocol;
issuing transactions to effect the request; and
producing a trading report.

2. The computer implemented decentralized method of claim 1, wherein the trading report comprises a market report and/or a chart.

3. The computer implemented decentralized method of claim 1, wherein the step of issuing transactions is initiated by a user; and issuing transactions to effect the request comprises the user gaining custody of a crypto bought from one blockchain in automated exchange for custody of a crypto used to pay from another blockchain in a single autonomous concurrent transaction.

4. The computer-implemented decentralized method of claim 1, further comprising:
supplying a reserve Quote Value denoted as Y; and
supplying a circulating Face Value denoted as X;
wherein the step of quoting a value comprises setting a price of exchange dy/dx equal to a ratio of the circulating face value X to the reserve quote value Y, where a product of X·Y equals at least one relationship selected from the group consisting of: (X+dx)(Y+dy); (X−dx)(Y+dy); (X+dx)(Y−dy); and (X−dx)(Y−dy).

5. The computer-implemented decentralized method of claim 1, wherein the step of quoting a value is performed for each of the multiple blockchain networks in parallel.

6. The computer implemented decentralized method of claim 1, wherein the step of quoting a value is automated, decentralized, and serialized by a longest chain consensus mechanism, said longest chain consensus mechanism being selected from the group consisting of: a proof of work, a proof of stake, a Proof of Relay; and a combination or variation thereof.

7. The computer-implemented decentralized method of claim 1, further comprising recording a history of published requests;
wherein the step of publishing the request is performed as an automated exchange protocol.

8. The computer-implemented decentralized method of claim 7, further comprising matching the request to a mating request having equal value from the history of published requests, wherein if the request is “sell”, the mating request is “buy”; and if the request is “buy”, the mating request is “sell”.

9. A system comprising:
decentralized processing computers operating together peer-to-peer in communication with multiple crypto currency blockchain networks via an internet connection; and
software executed by the decentralized processing computers to implement the computer-implemented decentralized method of claim 1.

10. The system of claim 9, configured to operate with a concurrent response flow.

11. A crypto currency super block comprising confirmed crypto blocks from multiple blockchains, the crypto blocks containing autonomous scrip processed as a unit by the computer-implemented decentralized method of claim 1.

12. The crypto currency super block of claim 11, wherein the crypto currency super block is hosted on multiple blockchains.
